(19) United States
(12) Patent Application Publication
(10) Pub. No.: US 2007/0187383 A1
(43) Pub. Date: Aug. 16, 2007

(54) Patterned conductive elements for resistively heated glazing

(76) Inventors: Richard T. Wipfler, Menlo Park, CA (US); Mukundan Narasimhan, San Jose, CA (US)

Correspondence Address: Law Offices of Terry McHugh, PMB 560, 101 First Street, Los Altos, CA, 94022, US

(21) Appl. No.: 11/655,498

(22) Filed: Jan. 19, 2007

Related U.S. Application Data
(60) Provisional application No. 60/760,072, filed on Jan. 19, 2006.

(51) Int. Cl. B60L 1/02

(52) U.S. Cl. 219/203

(57) ABSTRACT

In accordance with one approach to the invention, elements and sub-elements of a conductive pattern on or in an optical member are designed and arranged to be predominantly or exclusively curved, so as to control the appearance of ray-like disturbances during nighttime point-source viewing situations. In another approach, the sub-elements of the conductive pattern are designed and arranged so as to be a large number of short, linear or curved elements oriented with a large angular distribution.

### CROSS REFERENCE TO RELATED APPLICATION

This application claims priority from co-pending provisional application Ser. No. 60/760,072, filed Jan. 19, 2006.

### TECHNICAL FIELD

The invention relates generally to optical members having resistively heatable coatings and more particularly to patterning such coatings.

### BACKGROUND ART

Single layer or multi layer coatings are often used to achieve desirable optical characteristics for windows used in vehicles, homes and buildings. For example, Southwall Technologies, Inc. sells a film under the federally registered trademark XIR. The XIR film is incorporated into a glass lamination to significantly reduce solar heat gain through the glass lamination. The control of solar heating is significant to some applications, such as automobile windshields.

U.S. Pat. No. 6,204,480 to Woodard et al., which is assigned to the assignee of the present invention, describes the use of an optical coating on a vehicle window to heat the window for purposes of providing de-icing or defogging. The coating is a thin film stack that is electrically conductive, but is sufficiently thin to be substantially transparent. The term “transparent” is defined herein as the ability to transmit at least 30% of radiation within the visible range of the light spectrum. Electrical connections to the thin film conductive coating are provided by bus bars. The bus bars may be patterned to achieve desired current distribution or to focus heating into certain regions of the window. The patent is herein incorporated by reference.

U.S. Pat. No. 6,703,586 to Kast is also assigned to the assignee of the present invention and is incorporated by reference. Kast teaches that localized heating of a window, such as a vehicle windshield or sidelight, can be provided by dividing an electrically conductive optical coating into high and low heating zones.

It is well known that heat energy may be delivered to “glazing assemblies” by incorporating resistive heating elements either on or within the glazing assembly. Then, a voltage may be applied across the resistive heating elements to cause localized heating of the elements, resulting in heat transfer to the surface of the assembly. The purpose of the localized heating may be one or more of demisting, defrosting, de-icing, or improving human comfort. The resistive heating elements may be designed with a roughly sinusoidal two-dimensional pattern in the plane of the glazing and may comprise an array of electrically parallel opaque conductors with individual widths typically narrower than 75 microns. The waveform of the conductive elements may consist in part of repeating patterns which are substantially linear and substantially parallel to one another.

A concern with prior art approaches is that the incorporation of resistive heating elements on or within the glazing assembly may adversely affect the optical performance of the assembly. For example, when applied to a window of an automobile, visibility may be affected, particularly during nighttime driving.

### SUMMARY OF THE INVENTION

In accordance with the present invention, a pattern of conductive traces is designed to avoid occurrences of adjacent trace segments that are linear and parallel. It has been determined that multiple linear elements or sub-elements with predominantly parallel angular orientations are a basic cause of some optical distortions. Although spaced apart from one another, linear, parallel sub-elements of a conductive pattern may cause additive diffraction-like visual effects which can be annoying and distracting. The visual effects are easily noticed in transmissive viewing conditions in which a distant point source of light is viewed through a glazing that is close to the viewer, as would be the case with nighttime driving or riding in a vehicle with oncoming traffic or adjacent street and safety lighting. For example, occupants of a vehicle may notice two opposed rays emanating from an image of an external point source of light, with brighter sources creating more intense sets of rays. The ray-like disturbances are oriented at right angles to the predominant axes of the linear, parallel sub-elements of the heating elements.

In one embodiment, the pattern of electrically conductive traces is defined by a large angular distribution with respect to intersections among the traces. That is, the traces intersect at irregular angles, but combine to form electrical paths for the flow of current. Power connections, such as busbars, are provided to induce the current flow when a power source is connected. The pattern may be quasi random, as would be the case when the pattern includes randomization within a sub-pattern, but the sub-pattern repeats across the surface of a transparent member, such as a windshield. Individual traces may be linear, but the randomization avoids the occurrences of adjacent trace segments that are parallel.

Alternatively, the traces may be curved.

In another embodiment of the invention, the pattern is a continuous series of sub-elements that are preferably exclusively curved in the plane of the surface on which the sub-elements are formed. As one possibility, each conductive trace may be a resistive element in the form of a continuous series of semicircular trace segments. Alternatively, a resistive element may be a continuous series of quarter-arc trace segments or partial elliptical trace segments.

### BRIEF DESCRIPTION OF THE DRAWINGS

FIG. 1 is a schematic view of an indoor testing method used in determining the cause of the “star filter” effect and means for reducing or eliminating the effect.

FIG. 2 is a photograph of the “star filter” effect.

FIG. 3 is a schematic view of prior art straight traces connected to a bus bar for use with an automobile window or other optical member.

FIG. 4 is schematic view of prior art “wavy” traces as an alternative to the straight traces of FIG. 3.

FIGS. 5-9 are photographs taken through windows in order to show optical distortions as a result of heating elements.

FIG. 10 is a schematic view of an array of heating traces in accordance with one embodiment of the invention.

FIG. 11 is a schematic view of an array of heating traces in accordance with a second embodiment of the invention.

FIG. 12 is one period of a trace as shown in FIG. 10.

FIG. 13 is a comparison of optical effects of conventional microwires, the pattern of FIG. 10, and the pattern of FIG. 11.

FIGS. 14-17 show various alternative embodiments to the present invention.

FIG. 18 is another embodiment of the invention, wherein the pattern is formed of linear elements having irregular orientations.

FIG. 19 is a side view of metal traces on a glass plate.

FIG. 20 is an illustration of an example of a grating structure.

FIG. 21 is a schematic illustration of the principle of optical structure of a front headlight of a vehicle.

FIG. 22 is a schematic illustration of the area of directional lighting.

FIG. 23 is a schematic illustration of an experimental setup which may be used in evaluating samples.

FIG. 24 is a simulated image of illumination through a circular aperture.

### DETAILED DESCRIPTION

While the invention will be described primarily with respect to automobile windshields, other applications are contemplated. For example, the invention may be utilized with windows of homes or buildings or with reflective surfaces, such as rearview mirrors. In attempting to augment or supersede known films, such as XIR-type films sold by Southwall Technologies, prior art conductive patterns of elements and sub-elements were evaluated. Under certain likely viewing conditions, a negative viewing effect of the known heating elements was observed. The presence of conventional elements caused a pair of angularly crossed ray-like bright lines to be seen emanating from distinct point sources viewed at nighttime through the glass. A similar problem is reported with a microwire-heated backlight (rear window) in a vehicle when a driver views headlights of a following car reflected by the internal rearview mirror.

### A. Experimental Process

The problem of a “star filter” effect was identified with simulated microwire patterns (quarter-arcs+straight segments in modified sinusoidal pattern). A sample was taped to a car windshield. Observations and photographs showed the “star filter” effect during nighttime transmissive viewing conditions. The problem was confirmed using a second set of tests with a stationary car (headlines on and facing the viewing station) located approximately 80 feet from a conventional heatable windshield sample and two models with straight traces and simulated conventional traces. A modified set of continuous curvilinear lines containing no intentionally linear segments (i.e., made only of curved sub-elements) exhibited far superior performance in the nighttime point-source transmission situation. The ray-like bright lines were much reduced in intensity. Subsequently, further sets of various patterns, again made only with curved elements, exhibited virtually no ray-like bright lights.

For purposes of the experimentation, samples were all made with opaque ink or metal deposited on glass or film in various patterns and linewidths. The film samples were laminated in glass to reduce the effect of surface haze. The baseline heatable microwave windshield sample was not modified.

There were two test methods, namely the outdoor test method and the indoor test method. For outdoor testing, the sample was placed at a desired orientation (vertical or tilted) and the observer was situated such that the viewing zone of the glass (line of sight to the target) was approximately 45-50 cm from the eyes. The observer looked directly at one or a pair of vehicle headlights at a distance of 25 meters. The test was performed at nighttime in a low-light situation. General street lighting did not affect the test. The observations could also be made when viewing passing traffic while the vehicle was parked parallel to one side of a straight road. The observer viewed the subject patterned glazing sample and an unpatterned glazing sample of otherwise similar construction and noted the intensity and orientation of any ray-like patterns. A camera could be set to focus on the distant light sources in order to record the image.

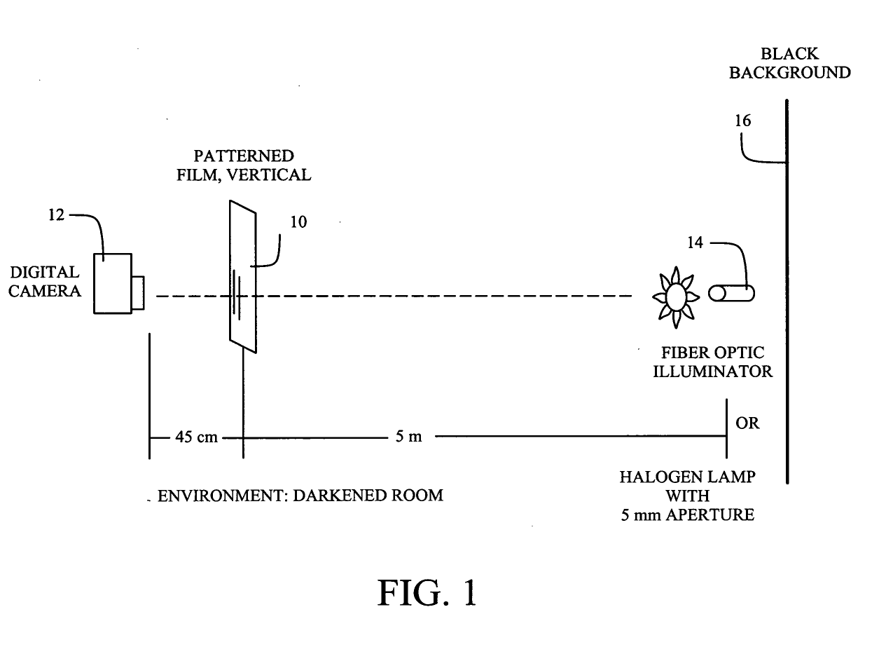

The indoor test is represented in FIG. 1. For the indoor test method, the sample 10 was placed at the desired orientation (vertical or tilted) and the observer (human or optical, such as a digital camera 12) was situated such that the viewing zone of the glass (line of sight to the target) was approximately 45-50 cm from the eyes, with the observer looking directly at a point source of light 14 at a distance of 5 meters. The test was performed in a darkened room, preferably with a dark background 16 behind the light source. The light source was adjusted by the choice of optics or an aperture plate to have a diameter within the range of 3 mm to 7 mm. A fiberoptic illuminator or indoor fifteen watt halogen lamp with a reflector could also be used. The observer viewed the subject patterned glazing sample and the unpatterned glazing sample of otherwise similar construction and noted the intensity and orientation of any ray-like patterns. Again, a camera could be set to focus on the distant light source in order to record the image.

In determining the results of the experimentation, it was noted that both the outdoor and the indoor tests showed that the conventional microwire heating glazing and the simulation of a similar pattern resulted in a double pair of objectionable diffraction-like rays seen to emanate from the light source. If the sample was rotated about the viewing axis slightly during the observation, the rays rotated exactly with the sample orientation. When the sample was tilted about the horizontal axis, the angles diminished, becoming closer to the horizontal plane. Other results were as follows:
(1) If a sample with a vertical straight-line pattern was observed, there was a single pair of rays emanating from the source, oriented at an angle normal to the lines in the pattern, in the same manner as a conventional diffraction grating;
(2) Measurements of the angles of the linear sub-segments in the simulated and the conventional microwire windshield showed that they were normal to the angles of the emanating ray pairs and that they were not the same angle in both samples. The effect seen with the straight-line samples showed that the straightness of the elements contributed to the problem. The orientation dependency of the paired rays on the angle of the straight sub-segments showed that the predominant orientation of even small sub-segments in a regular pattern is an important factor;
(3) The tilting of the sample affects the subtended angle of the linear elements and this explains the “flattening” effect viewed with the rays when the samples were tilted about the horizontal axis, further bolstering the theory of the elements as the root cause of the “star filter” effect;
(4) New patterns were developed. One pattern of stacked quarter-arcs used the same linewidth, curve radius and element spacing as the simulated microwave pattern. This pattern was used with no intentionally linear joining segments. The image resulting from this pattern had dramatically lower intensity rays. A pattern with semicircular elements had no diffraction-like rays. Yet another pattern made of elongated arcs had no diffraction-ray incidence. Moreover, another pattern made of stacked quarter-elliptical elements showed no diffraction-ray incidence;
(5) Further tests showed that varying the linewidths between 10 microns and 30 microns made no difference in the effect. The effect was strongly related to the presence and predominant angular orientation of linear sub-elements within the resistance heating pattern; and
(6) The predominance of the data showed the root cause of the effect and that the efficacy of many types of solutions were based on the understanding of root cause.

### B. Illustrated Experimental Results

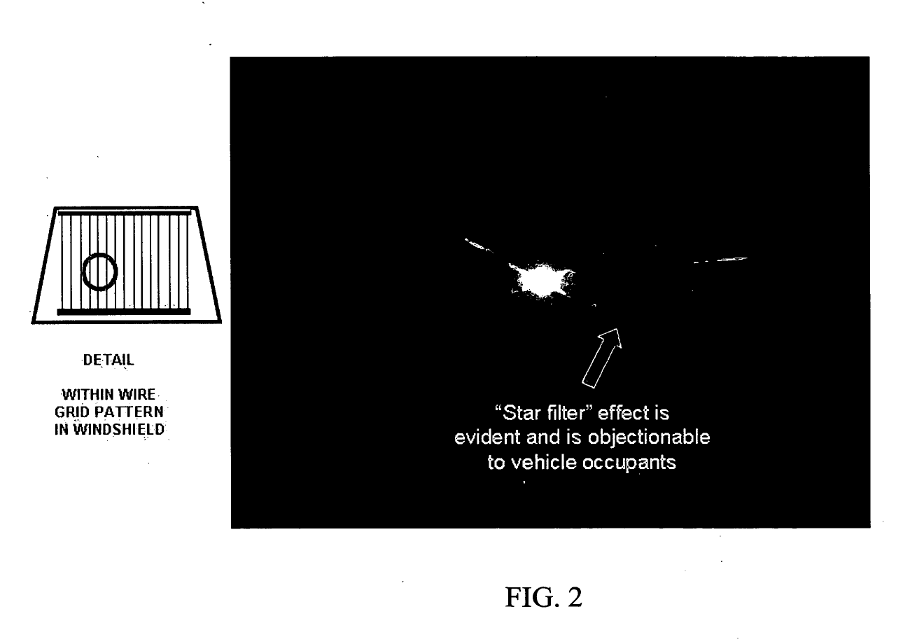

FIG. 2 illustrates the “star filter” effect that was referenced above. The photograph was acquired through a microwave heatable windshield sample from a Volkswagen vehicle design. As represented in the accompanying drawing, the microwires were arranged in parallel and were connected to a pair of bus wires that addressed the microwires with a controlled voltage. The effect is a negative factor with regard to marked penetration of heatable windshields. Through experimentation, it has been determined that the effect is primarily caused by the geometry of the repeating pattern. The width of the microwires was determined to be relatively unimportant, as was the color of the microwires.

The “star filter” effect is exhibited when a headlight or other bright point source is viewed in transmission in a darkened, night-like environment. In such a situation, the observer views a pair of extended rays emanating from the bright spot of the image.

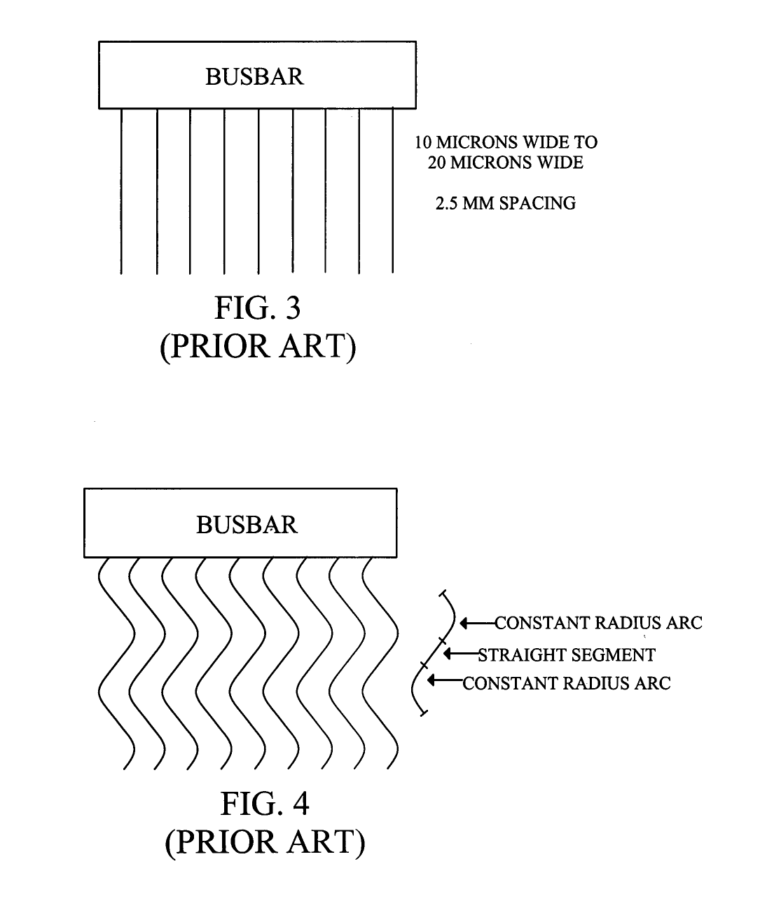

In experimentation, copper-on-glass patterns were photolithographically formed. Two prior art patterns are shown in FIGS. 3 and 4. In FIG. 3, copper traces are arranged in parallel and are shown as being connected to one of the bus bars 20. The copper traces may have a width of 10 or 20 microns and may have a spacing of 2.5 mm. In the pattern of FIG. 4, the copper traces 22 are “wavy.” Each trace alternates between a constant radius arcuate sub-segment and a straight sub-segment. As in FIG. 3, only one of the bus bars 24 is shown.

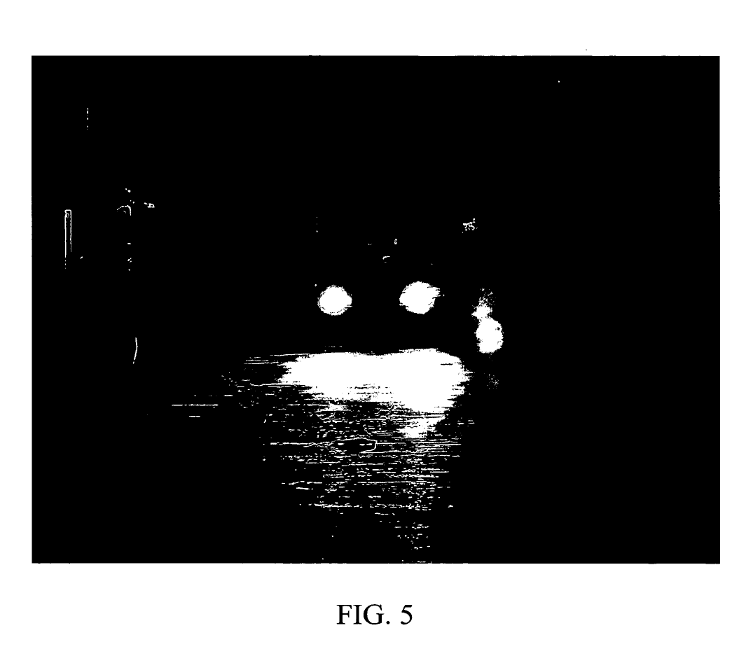

FIGS. 5-8 show photographs taken through windshields having a 45 degree tilt. In each case, the camera was approximately 18 inches from the windshield and was focused at infinity. The photographed vehicle was approximately 80 feet away.

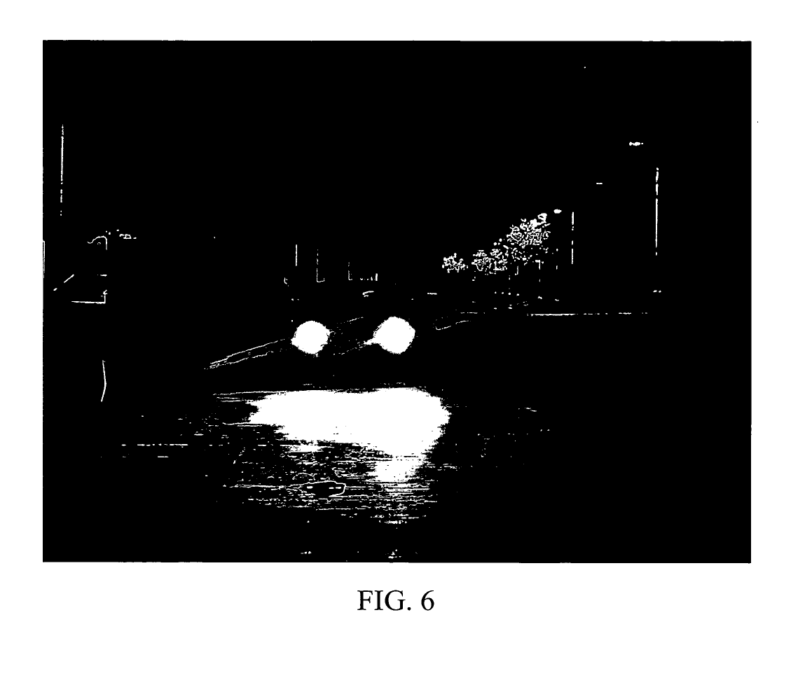

In FIG. 5, the photograph was taken through a “clear” region of the windshield. As can be seen, no “star filter” effect is evident. In comparison, FIG. 6 is a photograph through an array of straight traces, such as shown in FIG. 3. With the straight-line pattern, a single pair of rays are predominant in emanating from the point source, oriented at an angle generally normal to the lines in the pattern. This is typical of a conventional diffraction grating.

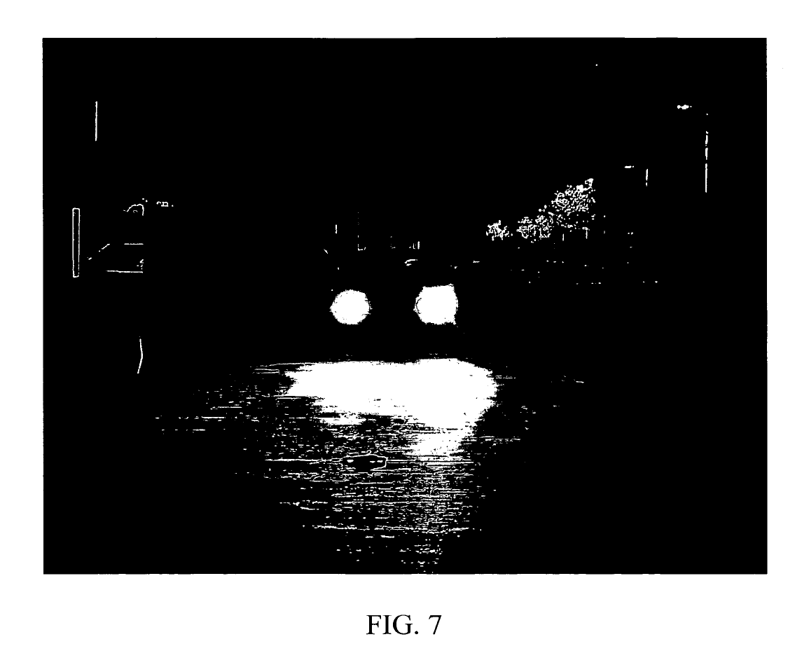

In FIG. 7, the photograph was taken through an array of “wavy” traces, such as the traces 22 shown in FIG. 4. The “star filter” effect is similar to that of FIG. 8, which was taken through “wavy” microwires which also included straight segments such as shown in FIG. 4. Measurements of the angles of the linear segments in the simulated traces and the conventional microwire windshield show that these angles are normal to the angles of the emanating ray pairs and they are not the same. Comparing FIGS. 6, 7 and 8, the effect seen with straight-line samples evidences the straightness of the elements contributes to the problem. The orientation dependency of the pair of rays on the angle of the straight segments in the “wavy” samples show that the predominant orientation of even small linear segments in a regular pattern is an important factor.

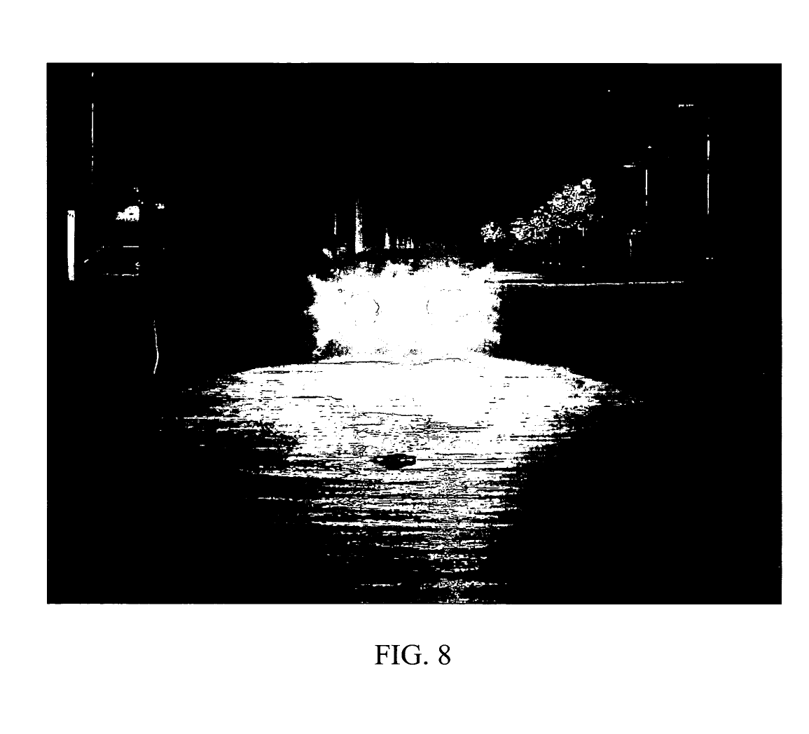

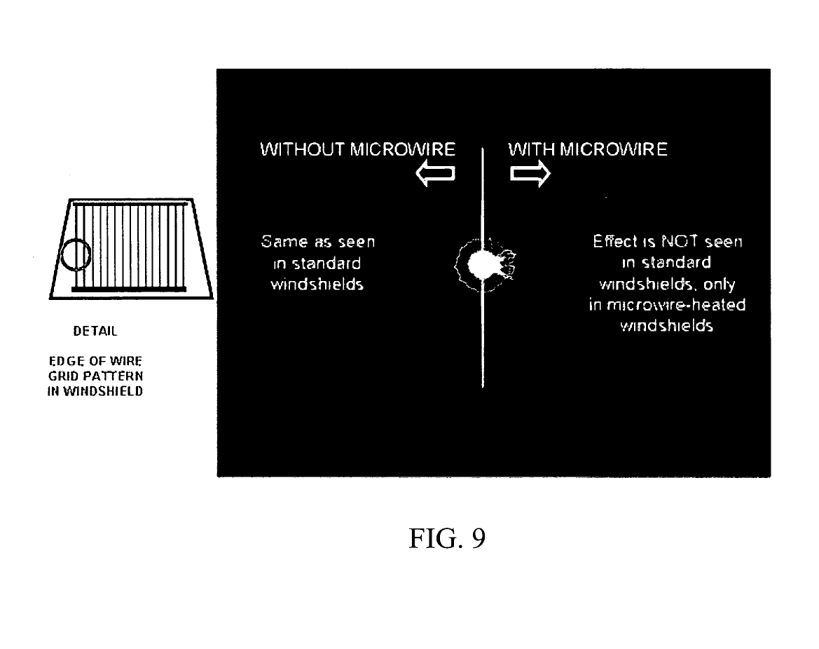

As a final illustration of the effect, FIG. 9 shows a photograph taken at the edge of the array of microwires, so that a portion of the image light is outside the array. As can be seen, the “star filter” effect is only predominant in the portion of the windshield that includes the microwires.

Thus, the problem was to design a heatable trace pattern with “parallel” resistance elements that reduce or eliminate the objectionable rays or “star filter” line image when viewed in nighttime point-source transmissive viewing conditions. The current invention addresses this problem by means of an improved design that eliminates or reduces the occurrence of angularly repeating linear elements or subelements within a field of resistive glazing heating elements, while maintaining the desired spatial density of the elements and the desired heating performance. The improved design uses predominantly curvilinear elements arrayed in a fashion so as to increase the angular dispersion of the subelements within the plane of the glazing, while still maintaining the desired element spatial density and heating performance.

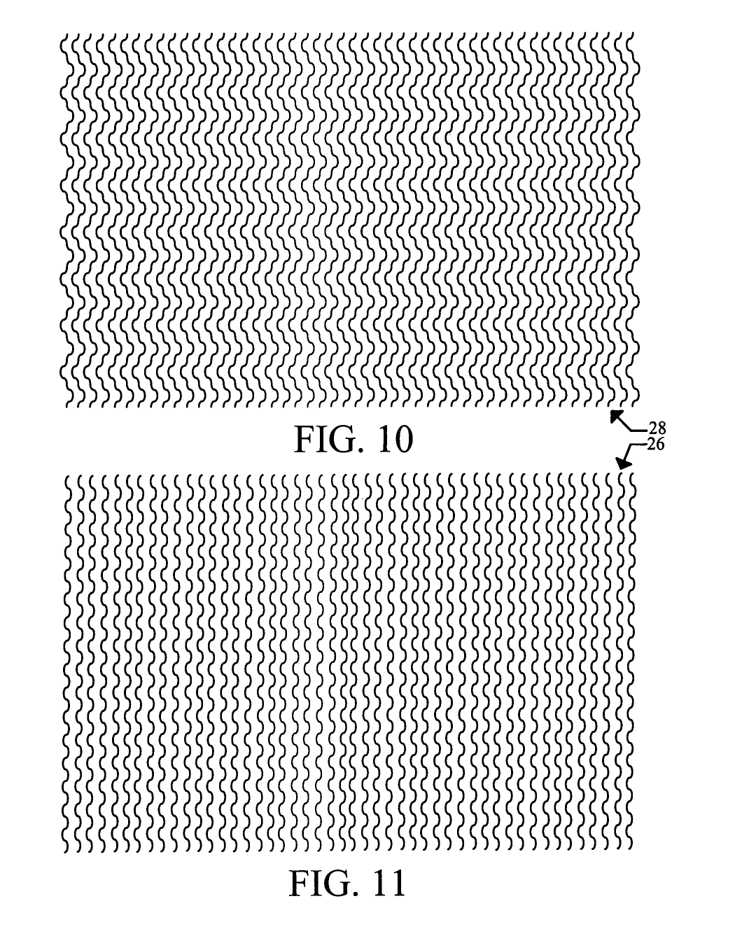

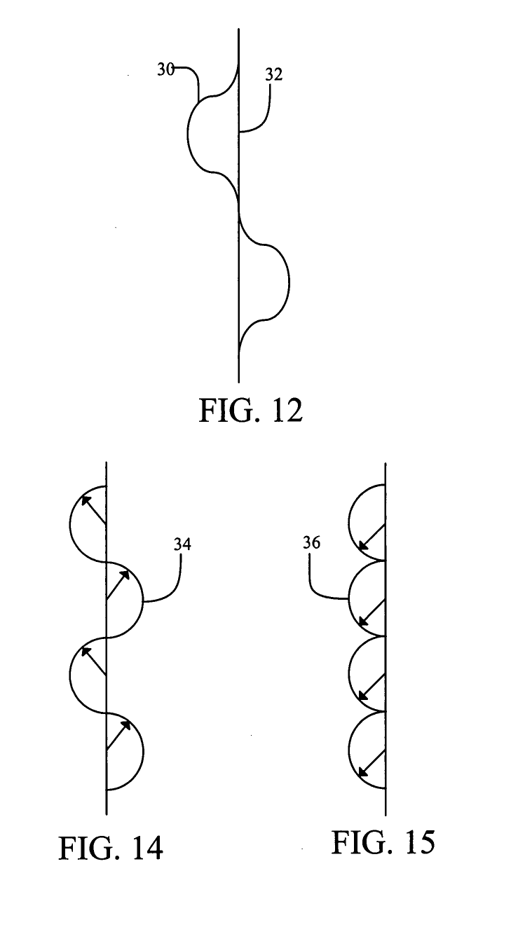

FIGS. 10 and 11 illustrate two embodiments of the invention. In FIG. 11, a serpentine quarter-arc pattern 26 of traces is shown. No portion of a trace is linear, since each trace is formed of a succession of quarter arcs. Similarly, there are no linear segments within the traces in the pattern 28 shown in FIG. 10. FIG. 12 shows one period of a trace from the pattern of FIG. 10. The trace 30 shown in FIG. 12 is a quarter-ellipse pattern. For purposes of explanation, a centerline 32 is shown in FIG. 12. The distance from the centerline to each apex of the trace may be 1.0 mm, but this is not critical.

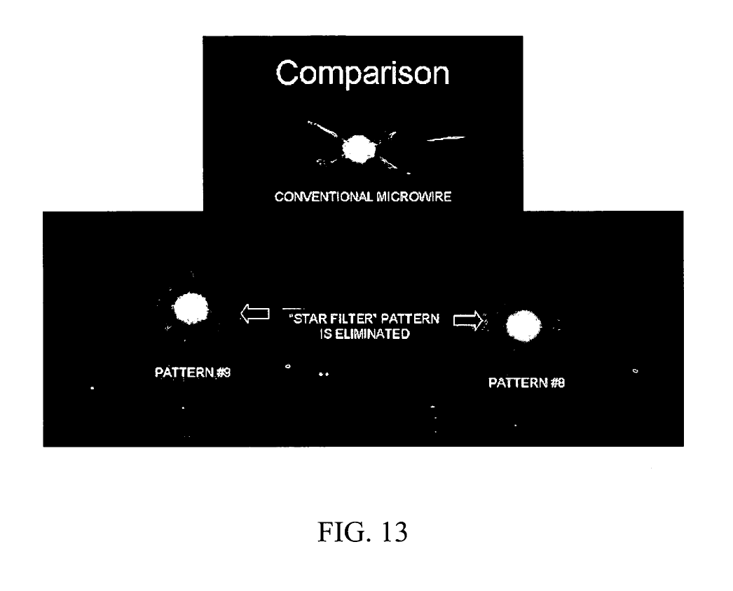

FIG. 13 shows a comparison of point source imaging through a conventional microwire (top image), through the serpentine quarter-arc pattern of FIG. 11 (lower left image), and through the quarter-elliptical pattern of FIG. 10 (lower right image). Using the patterns shown in FIGS. 10 and 11, the “star filter” effect is significantly reduced or eliminated. By designing the trace pattern to reduce or eliminate a predominance of similarly oriented linear features, it is possible to develop a conductively heatable array with a much-reduced or zero instance of diffraction ray patterns.

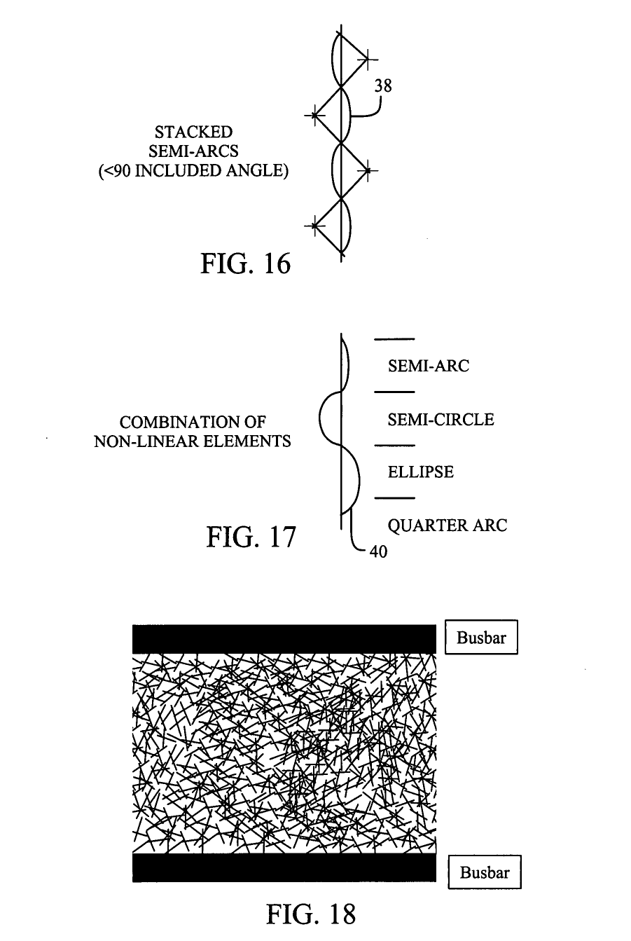

While not limiting, other contemplated patterns are shown in FIGS. 14, 15, 16 and 17. The serpentine trace 34 in FIG. 14 is formed by attached semicircles. Thus, adjacent semicircles are on opposite sides of a centerline. In comparison, the trace 36 in FIG. 15 is one in which the semicircles are “stacked.” That is, each semicircle is on the same side of a baseline. In FIG. 15, the trace 38 is formed of a succession of semi-arcs that have an angle of less than 90 degrees. A trace may also be formed of different non-linear elements. As one example, the trace 40 in FIG. 16 has a period formed of a semiarcuate segment, a semicircular segment, a semielliptical segment, and a quarter-arc segment.

There are also possibilities for forming traces that are defined by short, randomized linear elements. Because the orientation of the linear elements is non regular, the pattern is less susceptible to observation of the “star filter” effect. One embodiment is shown in FIG. 18. In this illustrated embodiment, there are repeating patterns of randomly angular elements, so that the element orientations are not strictly random.

### C. Quantitative Analysis

The microwire windshield prototype sample was analyzed visually and by spectrophotometer. The diffraction pattern can be described by considering grating theory. The basic equation of this theory is presented below.

$$sin {θ}_{m} = sin {θ}_{i} + m \frac{λ}{d}$$

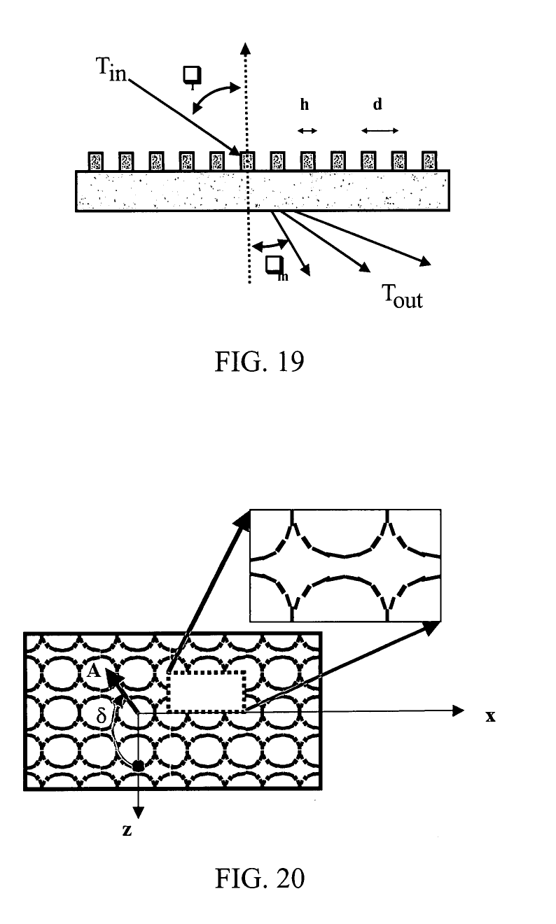

Here, the angles θᵢ and θₘ are represented in FIG. 19, m is an integer number, d is the period, and λ is wavelength. It is easy to see that diffraction angle θₘ depends on wavelength λ. It explains the coloration of the image. Moreover, in the particular case, the ratio between wavelength and the period is very small,

$$\frac{λ}{d} \sim {10}^{- 4}$$

That is why it is difficult to see the separate diffraction spots. We instead see a line.

Simple observation based on the above grating theory and super-position principle for lamellar gratings yield to a structure which may have a halo round headlights in the imaging plane. For example, when a glass plate with water droplets was tested visually, only halo was observed. The randomness in position as well as the circular nature of the droplets contributes to a more uniform halo instead of diffraction in a particular direction.

Candidates for a wire structure, which should have halo round headlights in the imaging plane include those shown in FIGS. 10 and 11, which were described above.

### 1. Quantitative Analysis of Diffraction Pattern of Conductive Metal Traces

Simplified problem. First we will use the superposition principle and will reduce the problem to the case of lamellar grating shown at FIG. 19. Then, we assume that there are three major areas with respect to FIG. 19: upper half space, y>a, with refractive index n₁, lower half space, y<0, with refractive index n₂, and modulated region, 0<y<a, with refractive index n(x, y). For each y, the function n(x, y) is a periodic function with respect to x, such that

$${k}^{2} ( x , y ) ≡ {( \frac{ω}{c} n ( x , y ) )}^{2} = {\sum }_{j = - ∞}^{∞} {g}_{j} ( y ) exp ( ⅈ \frac{2 π j}{d} x ) ,$$

where d>0 is the period. For example, in the case of silver lamellar structure shown in FIG. 19 with refractive index nl=0.05−i*2.87 at wavelength 500 nm, we have

$$n ( x , y ) = \{ \begin{matrix}{n}_{1} , & m d + h / 2 < x < ( m + 1 ) d - h / 2 , \\ n l , & m d - h / 2 < x < m d + h / 2.\end{matrix}$$

Here h is the wire width and m is an integer number. In this particular example, the refractive index of modulated area does not depend on y. Further, we assumed a monochromatic light source with incident angle θ₁ close to zero. Procedure of monochromatic light summation with photopic response curve will yield to a case of broadband light source.

Algorithm of Solution. We will use a standard solution of Maxwell equations for upper half space and for lower half space. The Maxwell equations for modulated area can be reduced to:

### ΔE_{z}+k²(x,y)E_{z}(x,y)=0

for TE polarization and

$$\frac{\partial {H}_{Z}}{\partial y} = {k}^{2} ( x , y ) {\tilde{E}}_{x} = 0 , \frac{\partial {\tilde{E}}_{x}}{\partial y} = - {H}_{z} - \frac{\partial }{\partial x} ( \frac{1}{{k}^{2}} \frac{\partial {H}_{z}}{\partial x} ) = 0$$

for TM polarization. These equations can be further reduced to the ordinary differential equations if we use periodicity of the electric and magnetic fields with respect to variable x. Both TE and TM polarizations are important for the evaluation of the light transmittance in the considering problem because λ/d<<1.

Boundary conditions are the continuity conditions for tangential components of electric and magnetic field at the boundary y=0 and y=a. Finite difference method together with the conditions of continuity leads to an algebraic system of equations with respect to Fourier coefficients of electric (TE polarization) and magnetic (TM polarization) fields.

Relative intensity of the transmitted light in the diffraction pattern and its color distribution will result from this simulation of electric and magnetic fields.

### 2. Statement of the Mathematical Problem

Let us assume that the grating structure (see the example of the grating structure of FIG. 20) has dₓ period with respect to the x direction and d_{z} period with respect to z direction; y-direction is a wave propagation direction. We consider a diffraction pattern produced by a plane wave with incident wavevector k̅₂ having the components
α₀=0, β₀=−k₀, γ₀=0,
and the polarization vector A̅ orthogonal to the wavevector having components (see FIG. 19)
Aₓ=−sin δ, A_{y}=0, A_{z}=cos δ

The incident electric field is chosen such that | A̅|=1V/m. Moreover, in the particular case the ratio between wavelength and the period is very small,

$$\frac{λ}{{d}_{x}} \sim \frac{λ}{{d}_{y}} \sim {10}^{- 4} .$$

Due to the x and z periodicity, the electric field in front of the glass with metal traces can be expressed by the sum of the incident electric wave and reflected waves

$$\overline{E} ( x , y , z ) = {\overline{E}}^{( i )} + {\sum }_{n = - ∞}^{+ ∞} {\sum }_{m = - ∞}^{+ ∞} {\overline{B}}_{n , m}^{( 2 )} exp [ ⅈ ( {α}_{n} x + {β}_{n , m}^{( 2 )} y + {γ}_{m} z ) ] ,$$

where

$${α}_{n} = \frac{2 π n}{{d}_{x}} , {γ}_{m} = \frac{2 π m}{{d}_{z}} , {β}_{n , m}^{( 2 )} = \sqrt{{k}_{0}^{2} - {α}_{n}^{2} - {γ}_{m}^{2}} .$$

The transmitted electric field can be represented by the expression

$$\overline{E} ( x , y , z ) {\sum }_{n = - ∞}^{+ ∞} {\sum }_{m = - ∞}^{+ ∞} {\overline{B}}_{n , m}^{( 1 )} exp [ ⅈ ( {α}_{n} x - {β}_{n , m}^{( 2 )} y + {γ}_{m} z ) ] .$$

The similar equations apply to magnetic fields in front and behind the window with metal traces. Inside the modulated area (glass with metal traces) we have Maxwell equations [1, 2] with a periodic permittivity

$$ɛ ( x , y , z ) {\sum }_{n = - ∞}^{+ ∞} {\sum }_{m = - ∞}^{+ ∞} {ɛ}_{n , m} exp [ ⅈ ( \frac{2 π n}{{d}_{x}} x + \frac{2 π m}{{d}_{z}} z ) ] .$$

Typical values for refractive indices of the aluminum and silver traces are shown in the Table 1.

TABLE 1
The refractive indices of aluminum and silver traces.

| Material | 400 nm | 500 nm | 600 nm | 700 nm | 800 nm |
|---|---|---|---|---|---|
| Aluminum | 0.4 − I*4.45 | 0.667 − I*5.573 | 1.043 − I*6.568 | 1.55 − I*7.0 | 1.99 − I*7.05 |
| Silver | 0.075 − I*1.93 | 0.05 − I*2.87 | 0.06 − I*3.75 | 0.075 − I*4.62 | 0.09 − I*5.45 |

Based on this approach we can develop an algorithm for the diffraction pattern | E̅(x, y, z,)|² evaluation.

### 3. Experimental Setup

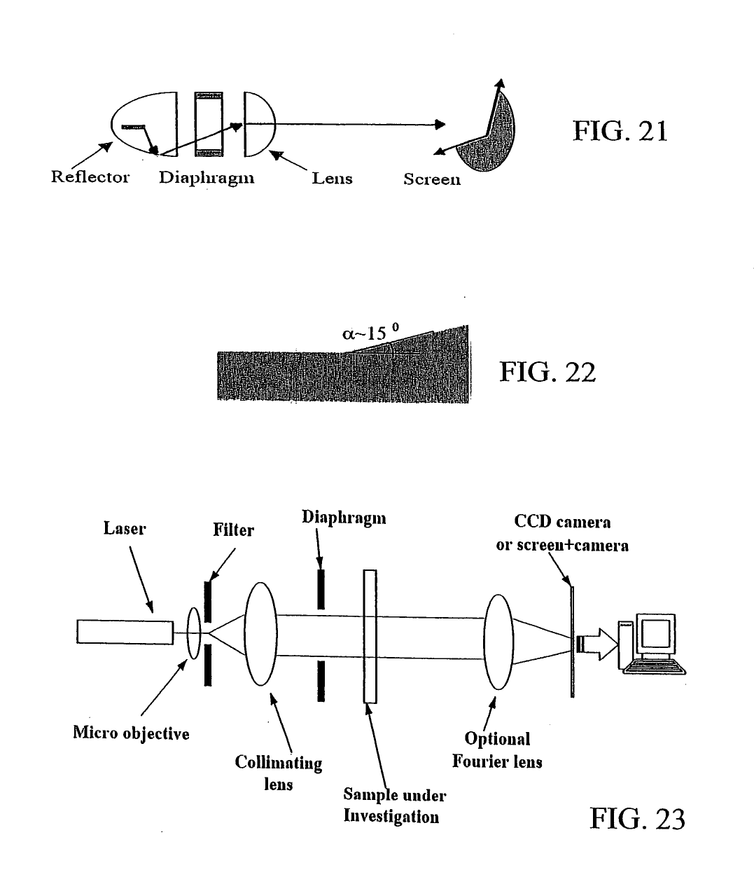

A simplified optical structure of an automotive headlight is shown at FIG. 21. The typical testing distance from the headlight to the registration plane is about 25 meters. Required shape of directional lighting at the registration plane is presented in FIG. 22.

A possible experimental setup for the testing of the glass/plastic plate with metal traces is shown at FIG. 23.

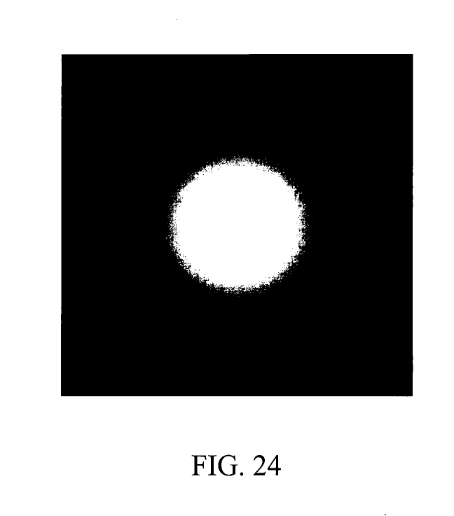

It is important to differentiate the diffraction pattern from aperture and a pattern produced by the diffused light. For example, at FIG. 24 we have a “halo”, which is the result of the Fraunhofer diffraction only without any additional scattering effect. The standard requirements to automotive headlight limiting this type of diffraction “halo” should be adopted when determining the experimental setup.

What is claimed is:

1. A window comprising:
a transparent member;
a pattern of electrically conductive traces designed to avoid occurrences of adjacent trace segments that are parallel and linear, said pattern being along a surface of said transparent member; and
power connections coupled to said pattern such that electrical current is induced to flow through said electrically conductive traces when a power source is connected to said power connections.

2. The window of claim 1 wherein said electrically conductive traces are resistive elements, such that heat is generated as a response to said flow of electrical current, said pattern being in thermal contact with said transparent member.

3. The window of claim 1 wherein said transparent member is a windshield of a vehicle.

4. The window of claim 1 wherein said pattern is defined by a large angular distribution with respect to intersections of said electronically conductive traces.

5. The window of claim 4 wherein said electrically conductive traces are individually short, but intersect at irregular angles to combine in an electrical path for said flow of electrical current.

6. The window of claim 5 wherein said pattern is formed as a repeating sub-pattern of said electrically conductive traces.

7. The window of claim 1 wherein said pattern is defined by said electrically conductive traces being curved along a plane of said surface of said transparent member, such that linear trace segments are avoided.

8. The window of claim 7 wherein each said electrically conductive trace is a continuous series of semicircular trace segments.

9. The window of claim 7 wherein each said electrically conductive trace is a continuous series of quarter-arc trace segments.

10. The window of claim 7 wherein each said electrically conductive trace is a continuous series of partial elliptical trace segments.

11. A window comprising:
a transparent member;
bus bars formed on said transparent member, said bus bars being connected to a source of electrical current; and
electrically resistive elements formed on said transparent member and connected to said bus bars to enable current flow between said bus bars, said electrically resistive elements being in a quasi-random arrangement in which said electrically resistive elements intersect in a plurality of different angles.

12. The window of claim 11 wherein said electrically resistive elements are linear but are non-parallel with respect to adjacent electrically resistive elements.

13. The window of claim 11 wherein said electrically resistive elements are arcuate and intersecting to form non-linear paths between said bus bars.

14. The window of claim 11 further comprising a solar control coating on said transparent member.

15. A window comprising:
a transparent member;
bus bars formed on said transparent member, said bus bars being connected to a source of electrical current; and
arcuate electrically resistive elements formed on said transparent member and connected to said bus bars to enable current flow therebetween, said arcuate electrically resistive elements having an absence of adjacent parallel sub-elements in order to retard visual effects of said arcuate electrically resistive elements.

16. The window of claim 15 wherein each said arcuate electrically resistive element is a continuous series of semicircular trace segments.

17. The window of claim 15 wherein each said arcuate electrically resistive element is a continuous series of quarter-arc trace segments.

18. The window of claim 15 wherein each said arcuate electrically resistive element is a continuous series of partial elliptical trace segments.
